(19) United States
(12) Patent Application Publication
(10) Pub. No.: US 2007/0220521 A1
(43) Pub. Date: Sep. 20, 2007

(54) Provision of services by reserving resources in a communications network having resources management according to policy rules

(75) Inventors: Michel Chevanne, Clamart (FR); Olivier Martinot, Draveil (FR); Gerard Delegue, Cachan (FR); Stephane Betge-Brezetz, Paris (FR); Emmanuel Marilly, Saint-Michel-Sur-Orge (FR); Fernando Cuervo, Ottawa (CA)

Correspondence Address: SUGHRUE MION, PLLC, 2100 PENNSYLVANIA AVENUE, N.W., SUITE 800, WASHINGTON, DC, 20037, US

(73) Assignee: ALCATEL, Paris (FR)

(21) Appl. No.: 10/567,758

(22) PCT Filed: Aug. 5, 2004
(86) PCT No.: PCT/FR04/02091

§ 371 Date: Dec. 14, 2006

(30) Foreign Application Priority Data
Aug. 12, 2003 (FR) 0309860

(51) Int. Cl. G06F 9/46

(52) U.S. Cl. 718/104

(57) ABSTRACT

A system (RMS) is dedicated to the management of resources within a communications network comprising a multiplicity of resources (NEQ, NEL) able to fulfill an assigned network role, defined by policy rules. The system (RMS) comprises i) policy management means (PM) charged with formulating the policy rules, ii) monitoring means (NRC) coupled to the resources (NEQ, NEL) and charged, when they receive a service provision request, with selecting a resource that satisfies a network role corresponding to the service, from among certain resources of the network which have not yet been associated with a processing role associated with the requested service, and with associating with this selected resource a processing role associated with the requested service, and iii) a policy server (PS) coupled to the monitoring means (NRC) and to the management means (PM) and charged with storing the policy rules and, when it receives the designation of the resource selected and of the associated network and processing roles, with determining from among the policy rules stored the policy rules which define the network role associated with the processing role so as to transmit them to the selected resource (NEQ, NEL) so that it instigate them.

The invention relates to the field of the management of the resources of a communications network.

Here, “resource” is understood to mean an item of network equipment, or an element of an item of network equipment, or else a network connection.

Moreover, “network equipment” is understood to mean any type of hardware, such as for example servers, terminals, switches, routers or concentrators, capable of exchanging data, in particular for management, according to a network management protocol with the network management system (or NMS) of the network to which it belongs. The network management protocol may for example be the SNMP protocol (standing for “Simple Network Management Protocol” RFC 2571-2580) used in particular in networks of IP or ADSL type, the TL1 protocol used in particular in networks of SONET type, the Q3 protocol used in particular in networks of SDH type, or else the CLI (control line) and CORBA (Common Object Request Broker Architecture) protocols.

Moreover, “element” is understood to mean any component of an item of network equipment capable of ensuring traffic processing, such as for example a card, an interface, a shelf, or a rack.

As the person skilled in the art is aware, the management of the resources of a network may be effected in two ways depending on the type of NMS management system used.

A first type relates to conventional NMS management systems in which all the information relating to the network (links, capacities, connections, and the like) are exchanged by way of a network management layer (or NML). In this first type, the NML management layer is therefore aware of the entire topology of the network and aware of its resources and manages everything.

This first type is very effective, but particularly expensive. Furthermore, the whole of the complexity of the network being integrated into the NMS management system, it is difficult to upgrade it and to keep it up-to-date. Moreover, the NMS management system is not well suited to task delegation to the equipment monitoring plane on account of the fact that the latter always comprises more intelligence and that it is more and more often being integrated within the equipment. Finally, certain types of service management are not easy to integrate into a conventional NMS management system. Each service management application must in fact form the subject of a hard-coding of its service logic, this taking time on account of the absence of an automated generation mechanism.

A second type relates to management systems with so-called “policy rules”. In certain communications networks, the resources are in fact managed as a function of a policy defined by policy rules. Here, “policy rule” is understood to mean a rule of the type “if <condition> then <action>”.

These policy rules define traffic processing, associated with services, which the elements or network equipment have to perform when they have instigated them.

Such policy-based management systems are described in particular in American patents U.S. Pat. No. 6,463,470 and U.S. Pat. No. 6,366,577 or in American patent application US 2004/0039803.

Stated otherwise, one or more policy rules define a network role that a resource has to ensure when it has been assigned to it. Patent application WO 03/012670 describes a policy-based management system using this concept of network role.

The operator (or supervisor) of a network therefore begins by assigning a network role to a resource, having regard to the service level agreements (or SLAs) made with the client(s) concerned, then it formulates one or more policy rules defining this network role which it then associates with the said role. These policy rules are formulated with the aid of a policy manager, then they are transmitted to a policy server charged with validating them, with storing them and with transmitting them selectively to the items of equipment concerned so that they instigate them.

This second type offers great flexibility in terms of defining new services, but, like the previous type, it does not have sufficient automated generation mechanisms, in particular as regards the verification of new policies, the creation of variants of new policies and the instigation of new policies (tasks which require the writing of specific programs for various parts of the management system). Furthermore, this second type does not offer any resource reservation mechanism. In most situations, the provision of a service in fact entails the allocation of resources, this being limiting.

No known management system affording entire satisfaction, the aim of the invention is therefore to improve the situation.

For this purpose, it proposes a method of resources provision for a communications network comprising resources suitable for fulfilling an assigned network role, defined by policy rules, consisting, when a service is requested, in selecting a resource that satisfies a network role corresponding to this service requested, from among certain resources of the network that have not yet been associated with a processing role associated with the service requested, then in associating with this selected resource a processing role associated with the requested service, and finally in determining from among a set of policy rules each policy rule which defines the network role associated with this processing role so as to transmit it to the resource selected so that it instigates it.

The method according to the invention can comprise other characteristics which could be taken separately or in combination, and in particular:

it is possible to select the resources from among registered resources. For example, each registered resource is designated by an identifier stored in correspondence with its traffic processing capacities. In this case, the resource selection can consist in verifying whether a registered resource has capacities making it possible to fulfill the network role which corresponds to the service chosen,

it is possible to store the resource identifiers in correspondence with network role and processing role identifiers which are possibly associated therewith,

it is possible to transmit the service provision request accompanied by a definition of the associated network role and by a definition of the associated processing role. However as a variant, the network roles can be stored in a roles memory, in order that on receipt of a service provision request it is possible to determine the corresponding network role in the memory, before proceeding with the selection,

it is possible to store the policy rules in correspondence with the associated network role,

it is possible to define each network role by at least one resource capacity,

it is possible to modify a network role when no resource fulfills this network role and/or when a resource fulfilling this role presents capacities compatible with the modification,

it is possible to delete a network role when no resource fulfills this network role,

it is possible to assign a network role directly to a resource when this resource has capacities which include each capacity designated by this network role,

it is possible to assign several (at least two) different network roles to certain resources,

before proceeding with a resource selection following a service request, it is possible to perform a preliminary phase consisting in determining in the set of policy rules whether one or more policy rules which define the network role which corresponds to the service requested exist.

The invention also proposes a resources management system, for a communications network, comprising a multiplicity of resources suitable for fulfilling an assigned network role, defined by policy rules, and comprising policy management means charged with formulating the policy rules and a policy server charged with storing the policy rules and transmitting them selectively to the resources so that they instigate them.

This management system is characterized in that, on the one hand it also comprises monitoring means coupled to the policy server and to the resources, and charged, when they receive a service provision request, with selecting a resource, which satisfies a network role corresponding to this service requested, from among certain resources of the network that have not yet been associated with a processing role associated with the service requested, and with associating with this selected resource a processing role associated with the service requested, and in that, on the other hand its policy server is charged, when it receives the designation of the selected resource and of the associated network and processing roles, with determining from among the policy rules stored the policy rule(s) which define the network role associated with the processing role so as to transmit it or them to the selected resource.

The management system according to the invention can comprise other characteristics which may be taken separately or in combination, and in particular:

monitoring means charged with determining the capacities of certain at least of the resources of the network so as to store them in a registrations memory in correspondence with a resource identifier, resources thus stored then being said to be registration sources,

monitoring means charged with selecting the resources from among resources registered in a registrations memory in the form of a resource identifier and of associated capacities. In this case, the monitoring means are charged, for example, with determining in the registrations memory each resource registered which has capacities making it possible to fulfill the network role corresponding to the chosen service,

monitoring means charged with storing the resource identifiers in the registrations memory in correspondence with network role and processing role identifiers which are possibly associated therewith,

monitoring means comprising graphics interface means allowing a user to communicate to them the definition of the network role associated with a requested service and/or the definition of the processing role associated with the said requested service. As a variant, the user communicates only the processing role definitions, the definitions of network roles being provided elsewhere and stored in a roles memory. In this case, when the monitoring means receive a service provision request, they determine in the roles memory a network role which corresponds to this service, before performing the selection,

monitoring means charged, when they receive therefrom the order of the graphics interface means, with modifying the definition of a network role designated if and only if no resource fulfills this network role or if and only if a resource fulfills this network role but has capacities compatible with the modification,

monitoring means charged, when they receive therefrom the order of the graphics interface means, with deleting a network role if and only if no resource fulfills this network role,

monitoring means capable of assigning a complementary network role to a resource when this resource has capacities which include each capacity designated by this network role,

monitoring means capable of assigning several different network roles to certain resources,

monitoring means capable, when they receive a service provision request and before proceeding with the resource selection, of addressing to the policy server a request for verification of existence of policy rule(s) corresponding to the service requested, so as to proceed with the selection only on condition that these rules exist,

a rules memory accessible to the policy server and storing the policy rules in correspondence with the associated network role,

mediation means interfaced between the resources, on the one hand, and the policy server and the monitoring means, on the other hand, and charged with ensuring the dialog, on the one hand, between the resources and the policy server or the monitoring means, and on the other hand, between the policy server and the monitoring means.

The invention furthermore pertains to a management server of a network management system (or NMS), equipped with a resources management system of the type of that presented hereinabove.

The invention is particularly well suited, although not exclusively, to the management of resources such as network equipment, elements of network equipment and network connections.

Other characteristics and advantages of the invention will become apparent on examining the detailed description hereinbelow, and the appended drawings, in which:

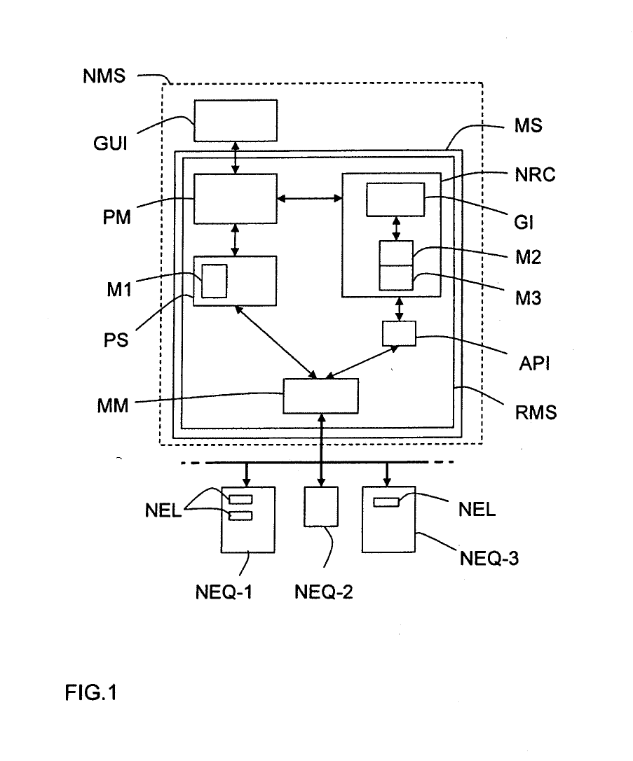

FIG. 1 illustrates diagrammatically an exemplary embodiment of a resources management system according to the invention, integrated into an NMS network management system, and

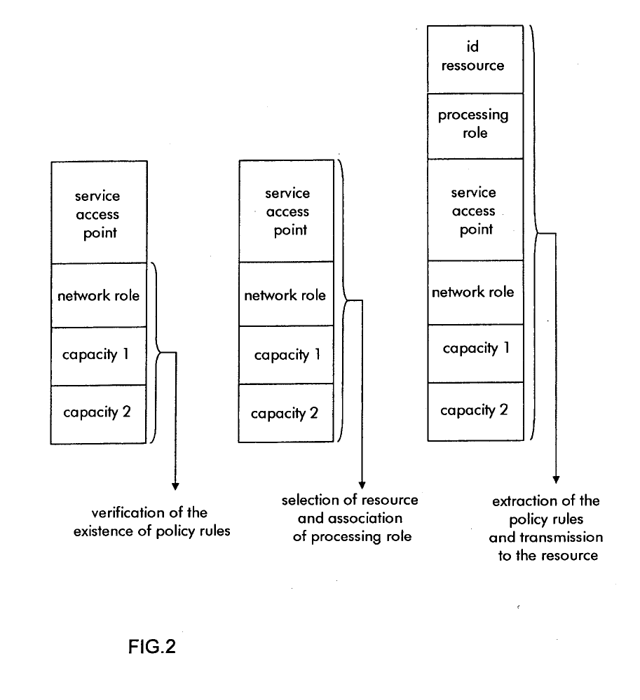

FIG. 2 illustrates diagrammatically an exemplary resource reservation according to the invention.

The appended drawings may not only serve to supplement the invention, but also to contribute to the definition thereof, as the case may be.

The object of the invention is to allow the reservation of resources within a communications network whose resources are managed with the aid of policy rules.

In what follows, by way of exemplary illustration the communications network will be considered to be at least in part of Internet type (IP). However, the invention applies to other managed types of network, such as for example to transmission networks of WDM, SONET or SDH type, to data networks of ATM type, or to voice networks of conventional type, mobile or NGN.

As illustrated in FIG. 1, a managed communications network is composed very schematically of a multiplicity of items of network equipment NEQ-i (here i=1 to 3, by way of example), linked together by communications means, and of a network management system (or NMS) intended to allow the manager (or supervisor) of the network to manage and monitor remotely the equipment NEQ-i to which it is coupled.

Here, “network equipment” NEQ-i is understood to mean an item of hardware capable of exchanging management data with the NMS network management system, and more precisely with an MS management server which it comprises, according to a chosen management protocol, such as for example the SNMP protocol (standing for “Simple Network Management Protocol” RFC 2571-2580), or the TL1, CORBA, CLI or Q3 protocols. These are, for example, peripheral servers or core servers, terminals, switches, routers or concentrators.

An item of network equipment NEQ-i may be constituted by a single network element NEL constituting a resource, or by several each, or together, constituting one or more resources. Here, “network element” is understood to mean any component of an item of network equipment NEQ-i capable of ensuring at least one traffic processing. These are for example a card, an interface, a shelf, or a rack. Moreover, here “traffic” is understood to mean both a flow of data packets and a single data packet.

As indicated hereinabove, the NMS network management system comprises an MS management server in which an RMS resources management system is preferentially installed, according to the invention.

This RMS resources management system comprises firstly a policy manager PM charged with the transformation into policy rules of the service level specifications (or SLSs) defining service level agreements (or SLAs) that the operator has made with his clients, and which are transmitted to him by the operator via a graphics interface of GUI type of the NMS network management system.

These policy rules are intended to define the traffic processing that the various items of network equipment NEQ-i and network elements NEL, and more generally the various resources, must perform in order to implement the services offered by the network.

The RMS resources management system also comprises a policy server PS fed with policy rules by the policy manager PM. It is more precisely charged with validating the policy rules that it receives from the policy manager PM, with storing them in a rules memory M1, and with transmitting them selectively, when ordered, to the network resources concerned (NEQ and NEL).

It is important to specify that the policy manager PM transmits to the policy server PS policy rules accompanied by an associated network role, to which we shall return later. Consequently, the policy server PS stores in the rules memory M1 a lookup table of correspondence between sets of network rules and roles (“rules/roles correspondence table”).

The policy manager PM and the policy server PS define a resource policy layer.

The RMS resources management system furthermore comprises a network resources monitor NRC which monitors the resources selection and reservation algorithm which will be described later. As may be seen later also, this network resources monitor NRC is also charged with registration, configuring and identifying resources in the guise of policy targets. Additionally, the topological aspect of a service being monitored via the network resources monitor NRC, the latter can be charged with creating certain resources, such as for example connections between NEQ equipment or NEL elements of the network.

This network resources monitor NRC is coupled, on the one hand, to the policy manager PM and, on the other hand, to the equipment NEQ-i and elements NEL of the network, preferably via at least one application programming interface of API type.

Preferably, as illustrated, and although this is not compulsory, the resources management system RMS comprises a mediation module MM interfaced between the resources NEQ-i and NEL, on the one hand, and the policy server PS and network resources monitor NRC, on the other hand. This mediation module MM is charged with ensuring the dialog, on the one hand, between the resources NEQ-i and NEL and the policy server PS or the network resources monitor NRC, and on the other hand, between the policy server PS and the network resources monitor NRC.

Such a mediation module MM is not needed when the equipment NEQ-i or elements NEL of the network comprise the policies directly. In this case the person skilled in the art calls the equipment “policy application points” (or PEPs standing for “Policy Enforcement Points”). As mentioned hereinabove, the network resources monitor NRC is charged with monitoring the resources reservation algorithm of the NMS network management system. It therefore comprises, preferentially, a graphics interface GI, of GUI type, intended to allow a user to transmit to it definitions of network roles and/or definitions of processing roles. The graphics interface GI could possibly allow the user to transmit service provision requests to the network resources monitor NRC, but it is preferable for these requests to reach the said network resources monitor NRC by way of the network manager PM (which generally receives them from the graphics interface GUI of the NMS network management system).

By definition, a network role defines a role that an item of network equipment NEQ-i or network element NEL, not designated, is able to fulfill within the network so as to implement a service or a part of a service. Stated otherwise, a network role is associated with a service, which corresponds to one or more traffic processings. Preferably, a network role is defined by at least one capacity for traffic processing of a resource (not designated), such as for example a functionality, such as the shaping of the traffic or a speed of processing.

It is important to note that a network role can be fulfilled only by resources of a certain type.

When the operator wants to proceed with the reservation of a resource, he must address a service provision request to the network resources monitor NRC. As indicated hereinabove, this request preferably reaches the network resources monitor NRC by way of the network manager PM. This request is accompanied either by the definition of the network role associated with the service and of the definition of an associated processing role (to which we shall return later), or only by the definition of an associated processing role. In the latter case, it is necessary for the network resources monitor NRC to have the definition of the network role associated with the service requested. For this purpose it comprises a roles memory M2, dedicated to the storage of the network role definitions communicated by the operator via the graphics interface GI.

Consequently, when the network resources monitor NRC receives a service provision request, either it is accompanied by a definition of network role or a processing role, or it is accompanied only by a processing role and the said network resources monitor NRC must extract from the roles memory M2 the network role definition which is associated with the service requested.

Once in possession of a network role, the network resources monitor NRC must proceed with the selection of a resource of the network which satisfies this network role. To do this, it performs its selection from among certain resources of the network which have not yet been associated with a processing role (or “business role”).

By definition, a processing role identifies the role of a resource chosen having regard to the specific characteristics of the service with which it is associated. A processing role is therefore intended to be associated with (or attached to) a resource which has been selected so as to fulfill a network role corresponding to a required service. Stated otherwise, a network role limits the use of a resource to a particular “instantiation” of a service, so that it acts as a sort of resource selection label. On the other hand, a processing role defines how the access of a particular client to a service access point should be configured. The word “configured” should be understood here within a very broad definition.

The network resources monitor NRC performs its selections from among so-called registered resources. A registered resource is a resource an identifier of which is stored in a registrations memory M3, possibly (and preferably) in correspondence with its traffic processing capacities.

The network resources monitor NRC is preferably charged with feeding this registrations memory M3 and with updating it. For this purpose, it can, for example, interrogate regularly (“polling”) the management information bases (or MIB) of the network equipment NEQ-i.

As a variant, the registrations memory M3 may be fed by another module of the NMS network management system.

The resource identifier is a unique identifier defined by a single naming service so that each resource of the network can be found independently of the network resources monitor NRC which manages them. Of course, the naming service may be constituted by a federation of naming subservices.

The resource selection consists either in verifying from among the registered resources those which are not attached to a processing role corresponding to the service requested and which have available capacities making it possible to fulfill the network role which corresponds to the service requested, or in creating a resource if this makes sense. This resource creation is under the responsibility of the network resources monitor NRC, it makes sense only for virtual resources (logic gate, disk space, etc.) but not for physical resources.

In order to allow this selection, the identifiers of the registered resources are stored in the registrations memory M3 in correspondence with the processing role and network role identifiers which are possibly associated therewith. The registrations memory M3 therefore stores a resources/roles correspondence table.

This selection phase may be preceded by a verification phase intended to ensure that there exist policy rules associated with the network role corresponding to the service requested. It is in fact preferable to verify whether the operator has defined policy rules corresponding to the service requested before attempting to find the resource which may fulfill the network role associated with this requested service.

This verification phase is illustrated very schematically by the stack on the left of FIG. 2. In the example illustrated, the operator wants to assign a chosen network role to a resource (to be determined) so that it provides peripheral access, for example for a service access point identified by complementary information. The network role chosen is for example defined by a first capacity related to the speed of processing (for example 100 Mb) and a second capacity related to the type of processing (for example shaping).

To perform the verification phase, the network resources monitor NRC addresses to the policy server PS, here by way of the mediation module MM, a request for verification of existence of policy rule(s) corresponding to the network role associated with the service requested (the request therefore comprises the definition of the network role manifested by the elements included in the brace of the stack on the left of FIG. 2).

On receipt of this request the policy server PS accesses the rules memory M1 so as to search through the policy rules/network roles correspondence table for the policy rules which correspond to the network role received.

Once the search has finished, the policy server PS addresses to the network resources monitor NRC, here by way of the mediation module MM, a report message specifying whether it does or does not have policy rules corresponding to the network role which it addressed to it.

If the policy rules do not exist in the rules memory M1, the network resources monitor NRC generates a warning message that it transmits to the operator via the graphics interface GI thereof. The operator can then generate the missing policy rules with the aid of the policy manager MP, which will transmit them thereafter to the policy server PS so that it stores them in the policy rules memory M1, after validation.

If the policy rules exist, the network resources monitor NRC can then select a resource from among the resources registered, as indicated hereinabove (it in fact uses the elements included in the brace of the stack in the center of FIG. 2). Then, it associates with (or attaches to) this selected resource (in fact to/with its unique identifier) a processing role which has been communicated to it by the operator via the graphics interface GI thereof. In the example illustrated, the processing role specifies that the resource selected should for example fulfill the network role specified so as to offer the client X access to the network.

It is important to note that the network resources monitor NRC may be induced to create a resource, such as for example a connection, when the latter does not exist.

The network resources monitor NRC can then address to the policy server PS, here by way of the mediation module MM, the definition of the network role, the definition of the processing role, the unique identifier of the resource selected and possibly complementary data detailing an instantiation of the service requested, such as for example the designation of a service access point. It also updates the resources/roles correspondence table of the registrations memory M3 by storing the identifier of the resource selected in correspondence with the network role and processing role identifiers that it has just assigned to it.

The policy server PS then accesses the rules memory M1 and uses the elements included in the brace of the stack on the right of FIG. 2 to extract the policy rules which will allow the resource selected (designated by its unique identifier) to configure itself so as to fulfill the network role which has just been assigned to it by the network resources monitor NRC.

Next, the policy rules extracted are transmitted by the policy server PS to the item of network equipment NEQ-i or to the network element NEL, constituting or comprising the resource selected, here by way of the mediation module MM, so that the resource instigate them. The resource is then reserved.

The network resources monitor NRC can also be devised in such a way as to ensure one or more complementary functions. Thus, it can be charged, when it receives therefrom the order of a user via the graphics interface GI thereof, with modifying the definition of a designated network role. Of course, this modification can arise only on condition that no resource fulfills the network role designated or else that there exists a resource fulfilling this network role but having capacities compatible with the modification.

To proceed with such modifications the network resources monitor NRC therefore proceeds firstly with an analysis of the roles memory M2 and registrations memory M3, then if the modification is possible it performs it by updating the roles memory M2.

The network resources monitor NRC may also be charged, when it receives therefrom the order of a user via the graphics interface GI thereof, with deleting a designated network role. Of course, this deletion can arise only on condition that no resource fulfills the designated network role.

To proceed with such deletions the network resources monitor NRC therefore proceeds firstly with an analysis of the resources/roles correspondence table stored in the registrations memory M3, then if the deletion is possible it performs it by updating the resources/roles correspondence table and the roles memory M2.

The network resources monitor NRC can also be charged, when it receives therefrom the order of a user via the graphics interface GI thereof, with assigning a complementary network role to a resource which already fulfills at least one network role. Of course, this assignment can arise only on condition that the resource has capacities which include each capacity designated by the complementary network role.

To proceed with such assignments the network resources monitor NRC therefore proceeds firstly with an analysis of the registrations memory M3, then if the assignment is possible it performs it by updating the resources/roles correspondence table stored in the registrations memory M3.

The resources management system RMS, according to the invention, and in particular its policy manager PM, policy server PS, network resources monitor NRC and mediation module MM, may be embodied in the form of electronic circuits, software modules (or computing modules), or a combination of circuits and software.

The invention also offers a method of provision of resources, for a communications network comprising resources able to fulfill an assigned network role, defined by policy rules.

It may in particular be implemented with the aid of the RMS resources management system presented hereinabove. The main and optional functions and sub-functions ensured by the steps of this method being substantially identical to those ensured by the various means constituting the RMS resources management system, only the steps implementing the main functions of the method according to the invention will be summarized hereinbelow.

This method consists, when a service is requested, in selecting a resource NEQ-i or NEL, satisfying a network role corresponding to this service, from among certain resources of the network which have not yet been associated with a processing role associated with the service requested, then in associating with this resource selected a processing role associated with the service requested, and finally in determining from among a set of policy rules each policy rule which defines the network role associated with this processing role so as to transmit it to the resource selected so that it instigates it.

The invention is not limited to the resources management system, management server and method implementations described hereinabove, merely by way of example, but it encompasses all the variants that may be envisaged by the person skilled in the art within the scope of the claims hereinbelow.

1. Method of service provision for a communications network comprising resources (NEQ, NEL) suitable for fulfilling an assigned network role, defined by policy rules, characterized in that it consists, in the case of a service provision request, in selecting a resource that satisfies a network role corresponding to the said service requested, from among certain resources (NEQ, NEL) of the network that are not yet associated with a processing role associated with the said service requested, then in associating with this selected resource a processing role associated with the said requested service, and in determining from among a set of policy rules each policy rule defining the network role associated with the said processing role so as to transmit it to the said resource selected with a view to its instigation.

2. Method according to claim 1, characterized in that the said resources are selected from among registered resources (NEQ, NEL).

3. Method according to claim 2, characterized in that each registered resource (NEQ, NEL) is designated by an identifier stored in correspondence with traffic processing capacities, and in that the said resource selection consists in verifying whether a registered resource has capacities making it possible to fulfill the network role corresponding to the said service chosen.

4. Method according to claim 3, characterized in that the said resource identifiers are stored in correspondence with network role and processing role identifiers which are possibly associated therewith, in a registrations memory (M3).

5. Method according to claim 1, characterized in that the said service provision request is transmitted accompanied by a definition of the associated network role and by a definition of the associated processing role.

6. Method according to claim 1, characterized in that the network roles are stored in a roles memory (M2), and in that on receipt of a service provision request the corresponding network role is determined in the said roles memory (M2), before proceeding with the said selection.

7. Method according to claim 1, characterized in that the said policy rules are stored in correspondence with the associated network role, in a rules memory (M1).

8. Method according to claim 1, characterized in that each network role is defined by at least one resource capacity.

9. Method according to claim 1, characterized in that a network role is modified when no resource fulfills the said network role and/or when a resource fulfilling the said network role presents capacities compatible with the said modification.

10. Method according to claim 1, characterized in that a network role is deleted when no resource fulfills the said network role.

11. Method according to claim 8, characterized in that a network role is assigned directly to a resource when the said resource has capacities including each capacity designated by the said network role.

12. Method according to claim 1, characterized in that at least two different network roles are assigned to certain resources.

13. Method according to claim 1, characterized in that before proceeding with the said resource selection, a preliminary phase is performed consisting in determining in the said set of policy rules whether it comprises policy rules defining the network role corresponding to the service requested.

14. Resources management system (RMS), for a communications network comprising a multiplicity of resources (NEQ, NEL) suitable for fulfilling an assigned network role, defined by policy rules, the said system comprising policy management means (PM) suitable for formulating the said policy rules and a policy server (PS) suitable for storing the said policy rules and for transmitting them selectively to the said resources (NEQ, NEL) so that they instigate them, characterized in that it furthermore comprises monitoring means (NRC) coupled to the said policy server (PS) and to the said resources (NEQ, NEL), and devised, in case of receipt of a service provision request, to select a resource that satisfies a network role corresponding to the said service requested, from among certain resources of the network that are not yet associated with a processing role associated with the said service requested, and to associate with this selected resource a processing role associated with the said service requested, and in that the said policy server (PS) is devised, on receipt of the designation of the said selected resource and of the associated network and processing roles, to determine from among the said policy rules stored each policy rule defining the network role associated with the said processing role so as to transmit it to the said resource.

15. System according to claim 14, characterized in that the said monitoring means (NRC) are devised so as to determine the capacities of certain at least of the resources (NEQ, NEL) of the network in such a way as to store them in a registrations memory (M3) in correspondence with a resource identifier, said resources stored then being said to be registration sources.

16. System according to claim 14, characterized in that the said monitoring means (NRC) are devised to select the said resources from among resources (NEQ, NEL) registered in a registrations memory (M3) in the form of a resource identifier and of associated capacities.

17. System according to claim 16, characterized in that the said monitoring means (NRC) are devised to determine in the said registrations memory (M3) each resource registered having capacities making it possible to fulfill the network role corresponding to the said chosen service.

18. System according to claim 15, characterized in that the said monitoring means (NRC) are devised to store the said resource identifiers in the said registrations memory (M3) in correspondence with network role and processing role identifiers which are possibly associated therewith.

19. System according to claim 14, characterized in that said monitoring means (NRC) comprise graphics interface means (GI) suitable for allowing the communication by a user of a definition of network role associated with a requested service and/or of a definition of processing role associated with the said requested service.

20. System according to claim 14, characterized in that the said monitoring means (NRC), on the one hand, comprise graphics interface means (GI) suitable for allowing the communication by a user of the definitions of processing roles associated with a requested service, and of definitions of network roles, and on the other hand, are devised to store the said network roles definitions communicated in a roles memory (M2) and, in case of receipt of a service provision request, to determine in the said roles memory (M2) a network role corresponding to the said service, before performing the said selection.

21. System according to claim 19, characterized in that the monitoring means (NRC) are devised, on receipt of a request originating from the said graphics interface means (GI) and querying a chosen modification of a network role definition, to proceed with the modification of the definition of the said network role when no resource fulfills the said network role or when a resource (NEQ, NEL) fulfills the said network role and has capacities compatible with the said modification.

22. System according to claim 19, characterized in that the said monitoring means (NRC) are devised, on receipt of a request originating from the said graphics interface means (GI) and querying a deletion of a network role definition, to proceed with the said deletion when no resource (NEQ, NEL) fulfills the said network role.

23. System according to claim 19, characterized in that the said monitoring means (NRC) are devised to assign a complementary network role to a resource (NEQ, NEL) when the said resource has capacities including each capacity designated by the said network role.

24. System according to claim 14, characterized in that the said monitoring means (NRC) are suitable for assigning at least two different network roles to certain resources (NEQ, NEL).

25. System according to claim 14, characterized in that the said monitoring means (NRC) are devised, in case of receipt of a service provision request and before proceeding with the said resource selection, to address to the said policy server (PS) a request for verification of existence of policy rule(s) corresponding to the said service requested, and, in case of receipt of a message signaling such existence, to proceed with the said selection.

26. System according to claim 14, characterized in that it comprises a rules memory (M1) accessible to the said policy server (PS) and storing the said policy rules in correspondence with the associated network role.

27. System according to claim 14, characterized in that it comprises mediation means (MM) interfaced between the said resources (NEQ, NEL), on the one hand, and the said policy server (PS) and the said monitoring means (NRC), on the other hand, and devised to allow a dialog, on the one hand, between the said resources (NEQ, NEL) and the said policy server (PS) or the said monitoring means (NRC), and on the other hand, between the said policy server (PS) and the said monitoring means (NRC).

28. Management server (MS) of a network management system (NMS), characterized in that it comprises a resources management system (RMS) according to claim 14.

29. Use of the method according to claim 1 for resources chosen from a group consisting of network equipment (NEQ), the elements (NEL) of network equipment (NEQ) and network connections.

30. Use of the resources management system (RMS) according to claim 14 for resources chosen from a group consisting of network equipment (NEQ), the elements (NEL) of network equipment (NEQ) and network connections.
